(19) United States
(12) Patent Application Publication
(10) Pub. No.: US 2015/0057060 A1
(43) Pub. Date: Feb. 26, 2015

(54) SYSTEMS, APPARATUS, AND METHODS FOR CONDUCTING A 3D PRINTER-BASED MULTIPLAYER ONLINE GAME VIA A COMMUNICATION NETWORK

(71) Applicant: 3D Total Solutions, Inc., Ridgefield, CT (US)

(72) Inventors: Ellen S. Ross, South Salem, NY (US); James Endee, Ridgefield, CT (US)

(21) Appl. No.: 14/329,229

(22) Filed: Jul. 11, 2014

Related U.S. Application Data
(60) Provisional application No. 61/868,199, filed on Aug. 21, 2013.
(60) Provisional application No. 61/933,141, filed on Jan. 29, 2014.

(51) Int. Cl. A63F 13/49; A63F 13/30

(52) U.S. Cl. CPC A63F 13/49; A63F 13/30
USPC 463/9

(57) ABSTRACT

An online game is conducted by providing one or more stereolithography (STL) files to a plurality of users, by a processor, via a network, wherein the one or more STL files define respective objects. Information relating to the respective objects is received, by the processor, from the plurality of users. A winner is selected from among the plurality of users, based on the information received from the plurality of users. In one embodiment, each of the plurality of users is associated with a respective 3-D printer.

This application claims the benefit of U.S. Provisional Patent Application No. 61/868,199, filed on Aug. 21, 2013, and of U.S. Provisional Patent Application No. 61/933,141, filed on Jan. 29, 2014. Each of the aforementioned provisional patent applications is incorporated by reference herein in its entirety for all purposes.

### TECHNICAL FIELD

This specification relates generally to systems and methods for conducting a multiplayer online game via a communication network, and more particularly to systems and methods for conducting a 3D printer-based multiplayer online game via a communication network.

### BACKGROUND

The 3D printer industry has experienced significant growth in recent years. Much of this growth is due to improvements in 3D printing technology that have made possible the construction of 3D printers that are sufficiently small and inexpensive to be offered to the general consumer.

To perform a print, a 3D printer machine typically obtains a design of a CAD model from a 3D printable file (e.g., a stereolithography file, referred to as an “STL” file) and applies an additive process by laying down successive layers of liquid, powder, paper or sheet material to build the model from a series of cross sections. These layers, which correspond to the virtual cross sections from the CAD model, are joined or automatically fused to create the final shape.

Many types of multiplayer online games have also experienced significant growth in recent years. Multiplayer online gaming enables a group of individuals to participate in a game despite being geographically separated. Popular types of multiplayer online games include war games, fantasy games, gambling, and many others. The demand for multiplayer online gaming continues to grow, and there is accordingly a continuing need for new types of multiplayer online games.

### SUMMARY

In accordance with an embodiment, a method of conducting an online game is provided. One or more stereolithography (STL) files are provided to a plurality of users, via a network, wherein the one or more STL files define respective objects. Information relating to the respective objects is received from the plurality of users. A winner is selected from among the plurality of users, based on the information received from the plurality of users.

In one embodiment, each of the plurality of users is associated with a respective 3-D printer.

In another embodiment, a single STL file defining a respective object is provided to each of the plurality of users. Alternatively, a plurality of STL files defining a plurality of objects may be provided to each of the plurality of users.

In another embodiment, a plurality of questions related to the respective objects is provided to the plurality of users. A respective plurality of answers to the plurality of questions is received from each of the plurality of users. In one embodiment, for each of the plurality of users, the plurality of answers received from the respective user is combined to generate a code, and the code is compared to a predetermined code to determine whether or not the respective user is the winner.

In another embodiment, a second STL file defining a key is provided to a selected one of the plurality of users. The key may be used to redeem a prize.

In another embodiment, a second STL file defining a special object is provided to a selected one of the plurality of users. The selected user is designated as a second winner based on the special object. In one embodiment, the special object comprises a letter of an alphabet, such as “W”.

In accordance with another embodiment, a system for conducting an online game is provided. The system includes a storage adapted to store one or more stereolithography (STL) files, each STL file defining a respective object. The system also includes a processor adapted to provide the one or more STL files to a plurality of users, via a network, receive, from the plurality of users, information relating to the respective objects, and select a winner from among the plurality of users, based on the information received from the plurality of users.

In accordance with another embodiment, a method of conducting an online game is provided. A plurality of questions relating to one or more objects defined by one or more stereolithography (STL) files is provided to a plurality of users, via a network. Information relating to the respective objects is received from the plurality of users, in response to the questions. A winner is selected from among the plurality of users, based on the information received from the plurality of users.

In one embodiment, the one or more STL files are provided to the plurality of users. The one or more STL files may define respective instances of a selected object.

In another embodiment, the plurality of questions relate to physical characteristics of the respective objects.

In accordance with another embodiment, a method of conducting an online game is provided. A plurality of stereolithography (STL) files is provided to each of a plurality of users, via a network, wherein the one or more STL files define respective objects related to a selected theme. A respective response comprising a respective identification of the theme is received from each of the plurality of users. A response correctly identifying the selected theme is determined, and a user who submitted the response is designated as a winner.

In one embodiment, the plurality of STL files define a plurality of objects. the plurality of STL files is provided to each of the plurality of users.

In another embodiment, the plurality of STL files define a plurality of objects related to a selected theme.

In another embodiment, a clue relating to the selected theme is provided to the plurality of users.

In accordance with another embodiment, a method of conducting an online game is provided. identifying information is received from each of a plurality of users. For each of the plurality of users, one or more objects defined by one or more stereolithography (STL) files are identified, the one or more objects being printable on a 3-D printer. Respective information relating to the respective one or more objects is received from each of the plurality of users. A reward is provided to one of the plurality of users based on the information received from the plurality of users.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system in accordance with an embodiment;

FIG. 2 shows components of a game manager in accordance with an embodiment;

FIG. 3 is a flowchart of a method of conducting an online game via a communication network in accordance with an embodiment;

FIG. 4 shows a web page in accordance with an embodiment;

FIG. 5 shows a web page in accordance with an embodiment;

FIG. 6 is a flowchart of a method of conducting an online game in accordance with an embodiment;

FIG. 7 shows a web page in accordance with an embodiment;

FIG. 8 shows an object printed by a 3D printer in accordance with an embodiment;

FIG. 9 shows a web page in accordance with an embodiment;

FIG. 10 is a flowchart of a method of conducting an online game in accordance with an embodiment;

FIG. 11 shows a web page in accordance with an embodiment;

FIG. 12 shows a web page in accordance with an embodiment;

FIG. 13 shows a web page in accordance with an embodiment;

FIG. 14 shows a special object printed by a 3-D printer in accordance with an embodiment;

FIG. 15 shows a key printed by a 3-D printer in accordance with an embodiment;

FIG. 16 is a flowchart of a method of conducting an online game in accordance with another embodiment; and

FIG. 17 shows an exemplary computer that may be used to implement certain embodiments of the invention.

### DETAILED DESCRIPTION

In accordance with an embodiment, a method of conducting a multiplayer game via a communication network is provided. One or more files, each defining a respective object printable by a 3D printer, are provided to a plurality of user devices, via a network. For example, each file may comprise a stereolithography (STL) file; however, other types of files defining objects printable by a 3D printer may be used. Information related to the respective objects associated with the one or more 3D print files is received from each respective user device. A winner is selected based on the information received from the user devices.

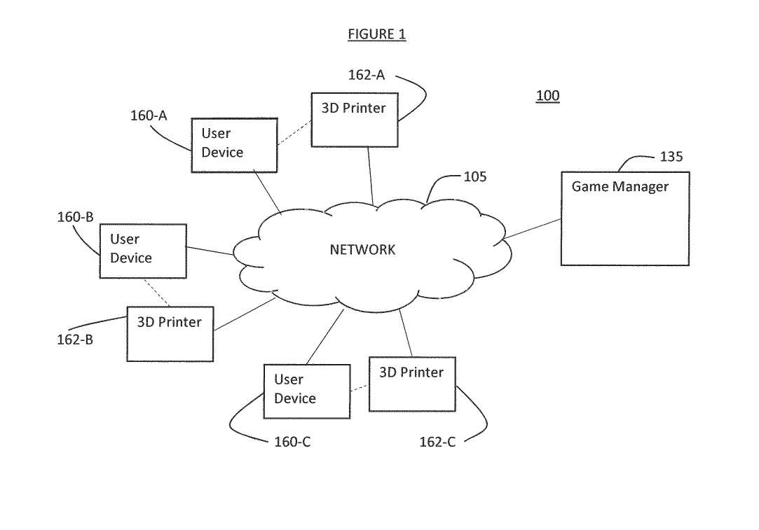

FIG. 1 shows a communication system 100 in accordance with an embodiment. Communication system 100 includes a network 105, a game manager 135, user devices 160-A, 160-B, 160-C, and 3D printers 162-A, 162-B, 162-C.

While three user devices and three 3D printers are shown in FIG. 1, communication system 100 may include more or fewer than three user devices and more or fewer than three 3D printers. For convenience, the term “user device 160” may be used herein to refer to any one of user devices 160-A, 160-B, or 160-C. Similarly, the term “3D printer 162” may be used herein to refer to any one of 3D printers 162-A, 162-B, or 162-C.

Network 105 may comprise one or more of a number of different types of networks, such as, for example, the Internet, a Fibre Channel-based storage area network (SAN), an iSCSI-based network, a local area network (LAN), a wide area network (WAN), a wireless network, etc. Other networks may be used.

User device 160 may comprise any processing device, such as a personal computer, a mobile telephone (such as a cell phone), a laptop computer, a tablet device, a personal digital assistant, a multimedia player, etc. Each user device 160 is connected to network 105 and may communicate with game manager 135 via network 105. Each user device 160 may also communicate with one or more 3D printers via network 105. Each user device 160 may also be connected directly to a corresponding 3D printer 162, as shown in FIG. 1.

In the illustrative embodiment, each 3D printer 162 comprises a 3D printer capable of printing an object based on a stereolithography (STL) file. Each 3D printer 162 may be any one of a variety of commercially available 3D printers, for example.

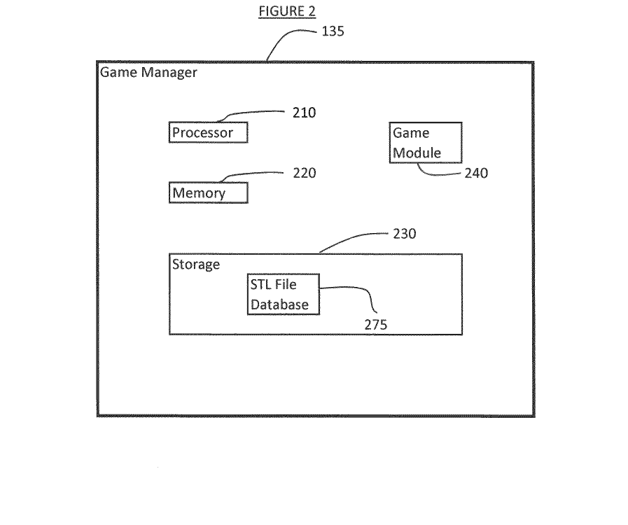

FIG. 2 shows components of game manager 135 in accordance with an embodiment. Game manager 135 includes a processor 210, a memory 220, a storage 230, and a game module 240. An STL file database 275 containing one or more STL files defining various objects is stored in storage 230.

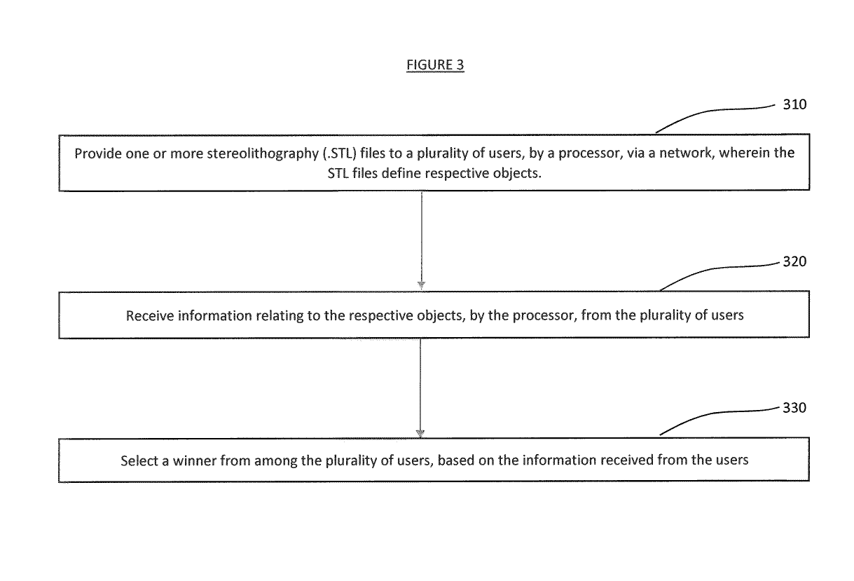

In one embodiment, game manager 135 conducts an online game in which respective users employing user devices 160-A, 160-B, 160-C, etc., are participants. FIG. 3 is a flowchart of a method of conducting an online game via a communication network in accordance with an embodiment. At step 310, one or more stereolithography (STL) files are provided to a plurality of users, by a processor, via a network, wherein the STL files define respective objects. At step 320, information relating to the respective objects is received, by the processor, from the plurality of users. At step 330, a winner is selected from among the plurality of users, based on the information received from the users. Various embodiments of the method are described below.

In a first illustrative embodiment, a user employing a user device 160 accesses, and logs into, a website managed by game manager 135, and accesses a web page associated with the online game. As each user logs in, game manager 135 determines the identity of the user and identifies the user device and 3-D printer that he or she is using.

Game manager 135 may provide a separate user web page for each user who logs in. On each respective user web page, game manager 135 may prompt the user to enter information identifying a 3D printer that he or she will be using. Alternatively, game manager 135 may obtain such information automatically from each user device 160.

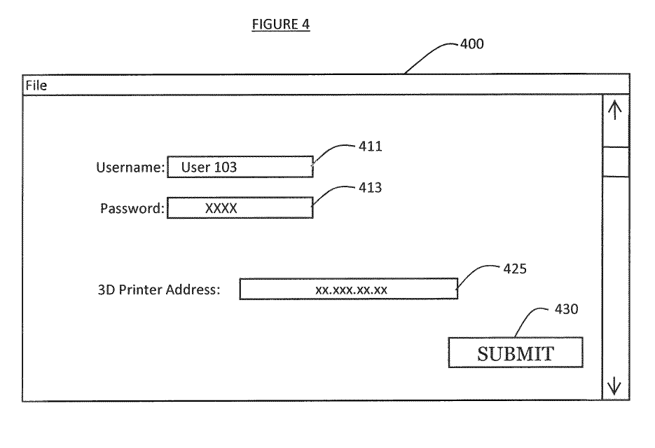

In an illustrative embodiment, a user employing user device 160-A and 3-D printer 162-A logs into the website using a web page such as that shown in FIG. 4. Web page 400 comprises a username field 411 in which a user enters a username, and a password field 413 in which the user enters a password. In the illustrative example of FIG. 4, the user enters the username “User103” and password “XXXX.” Page 400 also includes a 3-D printer address field 425 in which the user may enter an address of his or her 3-D printer. After entering the specified information, the user may select a “SUBMIT” button 430 to submit the information to game manager 135. The user is then logged into the game website and may proceed to play one or more online games.

While in the illustrative embodiments described herein, web pages are used as interfaces to enable a user to communicate with game manager 135, in other embodiments, other types of interfaces may be used. For example, a mobile application (App), or a page or screen associated with by a mobile application and displayed on a display screen of a mobile telephone, may be used.

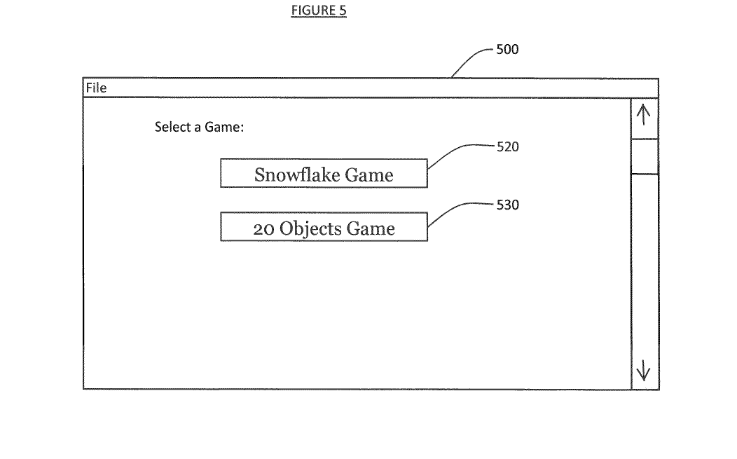

Game manager 135 now causes user device 160-A to display a game selection page such as that shown in FIG. 5. Page 500 shows options corresponding to several games that are available to be played. The options include a “Snowflake Game” option 520 and a “20 Objects Game” option 530. These options are illustrative. Other game options not shown in FIG. 5 may be presented. Similarly, in other embodiments, other games not described herein may be provided.

In the first illustrative embodiment, the user selects “Snowflake Game” option 520. In response, game manager 135 proceeds to conduct an online game referred to as the “Snowflake Game,” which is described below.

The “Snowflake Game” is an online game to be played by a plurality of participants. Thus, it is supposed that, in addition to the first user employing user device 160-A, a second user employing user device 160-B and 3-D printer 162-B, and a third user employing user device 160-C and 3-D printer 162-C, also access the game website maintained by game manager 135. Each of the users logs in and chooses the “Snowflake Game” option 520 (shown in FIG. 5) in order to play the “Snowflake Game.”

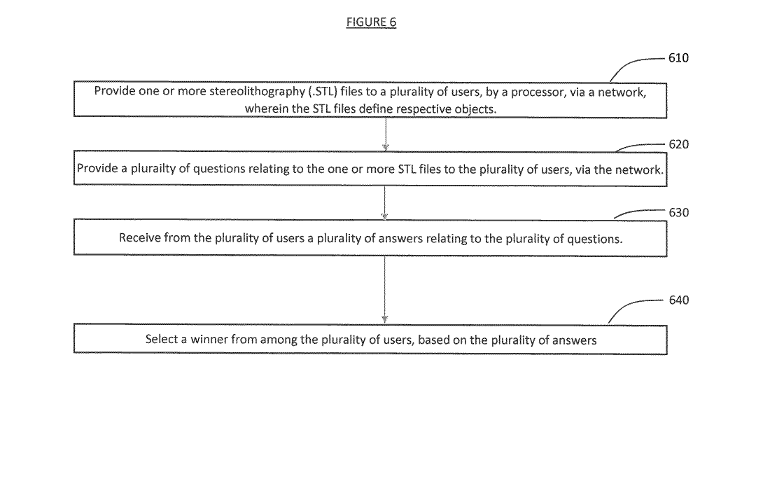

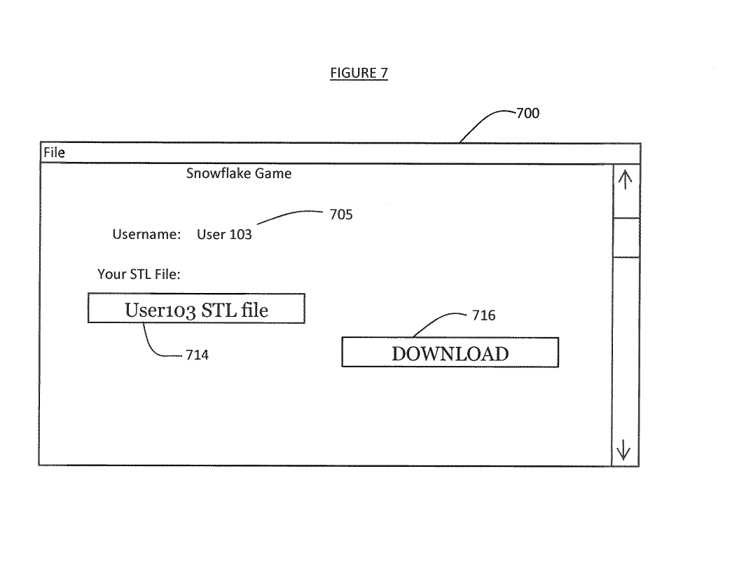

FIG. 6 is a flowchart of a method of conducting an online game in accordance with an embodiment. At step 610, one or more stereolithography (STL) files are provided to a plurality of users, by a processor, via a network, wherein the STL files define respective objects. After determining each user's identity, and identifying each user's user device and 3D printer, game manager 135 provides to each user a stereolithography (STL) file defining a particular object. In one embodiment, game manager 135 posts the STL files on each user's respective user web page, enabling the user to download the STL file. FIG. 7 shows a web page 700 provided for the user of user device 160-A, who is identified by username “User103.” An STL file 714 associated with the user (and identified as “User103 STL File”) is posted on web page 700. In the illustrative embodiment of FIG. 7, the user downloads the STL file to user device 160-A by selecting a “Download” option 716. The STL file may be stored in a memory of user device 160-A, for example.

In another embodiment, game manager 135 transmits to each user device 160 an STL file defining a particular object. In another embodiment, the STL file may be transmitted directly to the 3D printer associated with a user's user device.

In one embodiment, users are allowed to log in and download STL files starting at a predetermined date and time, for example, 8:00 PM on a specified date. In another embodiment, users may log in and register at any time, but STL files are not distributed until a predetermined date and time.

The STL file may define any object that is printable by a 3D printer. For example, the STL file may define a cup, a knife, a ring, etc. In an illustrative embodiment, each user device receives a different STL file defining a different object. In other embodiments, all user devices receive the same STL file.

In one embodiment, the STL files provided to various user devices define respective instances of a selected object. For example, in an illustrative embodiment, each user employing a user device 160 obtains an STL file which defines a respective snowflake (by downloading the STL file from the user web page, for example); however, each snowflake is unique. Thus, for example, the snowflake defined by the STL file received by user device 160-A is different from the snowflake defined by the STL file received by user device 160-B, etc.

In the illustrative embodiment, each STL file is encoded so that a user cannot view or otherwise determine the nature of the object defined by the STL file except by printing the file using a 3D printer.

Each user device 160 provides the STL file to the associated 3D printer 162 and instructs the 3D printer to print the object defined by the STL file. Thus, for example, after user device 160-A downloads STL file 714 from web page 700, user device 160-A provide STL file 714 to 3D printer 162-A and instructs the 3D printer to print the object defined by the STL file. In response, the 3D printer begins to print the object. In the illustrative embodiment, 3D printer 162-A begins to print the snowflake defined by the STL file.

In some embodiments, a user at each user device 160 must select an option (e.g., press a button on a display) to cause the 3D printer to print the STL file.

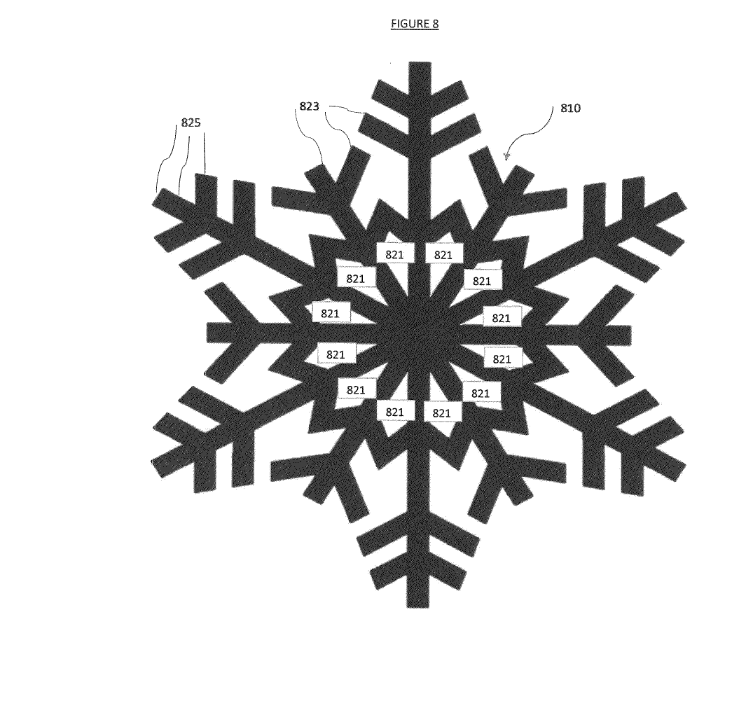

FIG. 8 shows an object 810 that may be printed by a 3D printer in accordance with an embodiment. In the illustrative embodiment of FIG. 8, object 810 is a snowflake. The snowflake comprises physical characteristics including a plurality of diamonds 821, a plurality of points 823, a plurality of edges 825, etc.

Referring again to FIG. 6, at step 620, a plurality of questions relating to the one or more STL files are provided to the plurality of users, via the network. In the illustrative embodiment, as the STL files are being printed, game manager 135 presents to each user (on the user's web page) a set of questions. The timing of the questions may vary. In one embodiment, game manager 135 presents a plurality of questions simultaneously. In another embodiment, game manager 135 monitors the progress of a user's 3D printer and presents selected questions to the user at selected points during the printing process. In another embodiment, game manager 135 presents questions at predetermined intervals after the printing process begins (regardless of the progress of the 3D printer). In another embodiment, game manager 135 presents a first question, and as soon as the user answers the question, game manager presents another question.

The questions may pertain to any aspect of the objects printed by the users' 3D printers, such as, for example, physical characteristics of the objects, names of the objects, sizes of the objects, use or function of the objects, locations of the objects, etc.

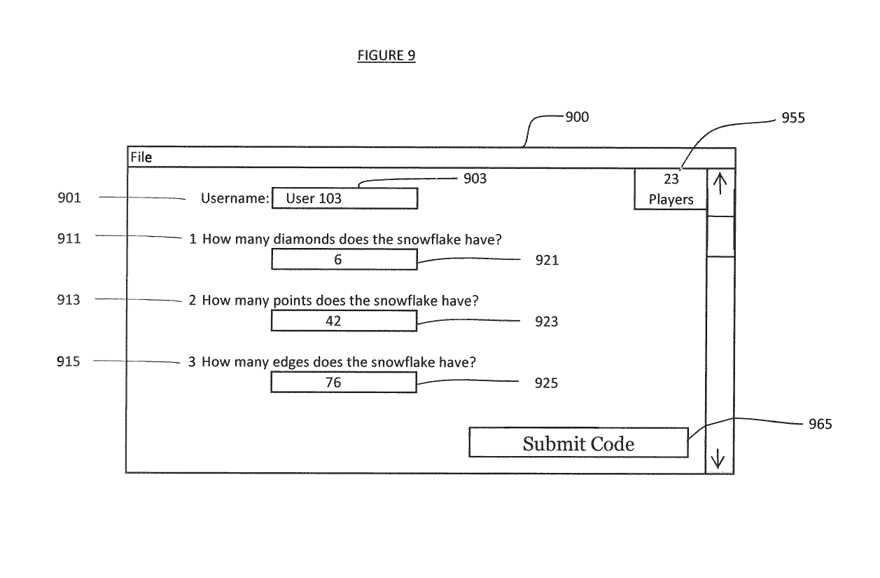

In the illustrative embodiment, game manager 135 presents to each user (on the user's web page) a series of questions relating to the snowflake that is being printed by the user's 3D printer. FIG. 9 shows a web page displaying a series of questions posed to a user in accordance with an embodiment. Web page 900 displays a username line 901, including the particular user's username (“User103”) shown in a username field 903. Web page 900 also includes questions 911, 913, 915. More or fewer than three questions may be presented. In the illustrative example of FIG. 9, game manager 135 first asks “How many diamonds does the snowflake have?” After the user answers the first question (in an answer field 921), game manager 135 poses a second question, “How many points does the snowflake have?” The user may answer the question in a second answer field 923. Game manager 135 subsequently presents an additional question, “How many edges does the snowflake have?” etc. The user may answer the third question in an answer field 925.

At step 630, a plurality of answers relating to the plurality of questions are received from the plurality of users. In the illustrative example, the questions are presented successively, and the user answers each question in succession. Specifically, in the illustrative embodiment, the user enters “6” in field 921, “42” in field 923, and “76” in field 925, representing answers to questions 911, 913, and 615. After answering all of the questions, the user may indicate that he or she has answered all of the questions, for example, by pressing a “SUBMIT CODE” button 965 displayed at the bottom of web page 900. When the user selects SUBMIT CODE button 965, game manager 135 combines the answers provided by the user into an alphanumeric code. For example, game manager 135 may concatenate the answers to the questions, in an order corresponding to the order in which the questions were presented, to generate an alphanumeric code comprising a plurality of alphanumeric characters. Thus, in the illustrative example, game manager 135 concatenates the user's answers to generate the code “64276.”

At step 640, a winner is selected from among the plurality of users based on the plurality of answers. In the illustrative embodiment, game manager 135 receives answers from each user participating in the game and generates a code for each user. Game manager 135 now compares the alphanumeric codes to a predetermined winning code to determine a winning user. Specifically, game manager 135 identifies a user having a code that matches the winning code and designates that user as the winning user. More than one winner may be identified.

In other embodiments, a winning code may be generated (randomly or otherwise) after game manager 135 receives answers from the various users.

In one embodiment, only one winning code is used, and game manager 135 designates a single winner. In another embodiment, multiple winning codes may be generated, and game manager 135 may identify multiple winners. In another embodiment, multiple winning codes may be generated, and game manager 135 identifies multiple potential winners by determining the users whose alphanumeric codes match one of the winning codes; however, the final winning user is the user who first submitted a matching alphanumeric code.

In one embodiment, game manager 135 may display the number of participants (users who are playing the game) on each user's web page. Referring to FIG. 9, the number of participants (23) is displayed in a field 955 in the top right corner of page 900. Field 955 may be updated in real time as players join or leave the game. Advantageously, informing users of the number of participants in a game may motivate users to submit their answers as quickly as possible.

In another embodiment, game manager 135 is operated by a first entity. Users log into a first website maintained by game manager 135 to enter the game and to obtain an STL file, and to view the questions related to the printable object defined by the STL file. However, each user must access a second website operated by a second entity (for example, a sponsor) to submit the answers to the questions, and to find out if he or she is a winner.

In a second illustrative embodiment, game manager 135 conducts a game referred to as “20 Objects.” Game manager 135 provides to each user (via the user's web page, for example, or to each user device 160, or directly to each 3D printer) a plurality of STL files each defining a respective object. For example, twenty STL files defining 20 objects may be provided to each user. The objects are related to a common theme. For example, all the objects may pertain to a particular sports team, film, novel, historical figure, etc. Game manager 135 then conducts a game in which participants must print out the objects defined by the STL files, and determine the common theme. The user or users who first identify the common theme are designated the winners.

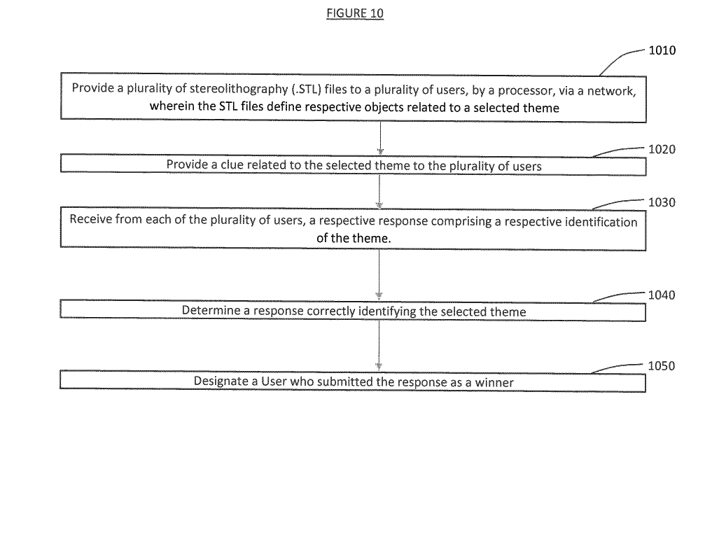

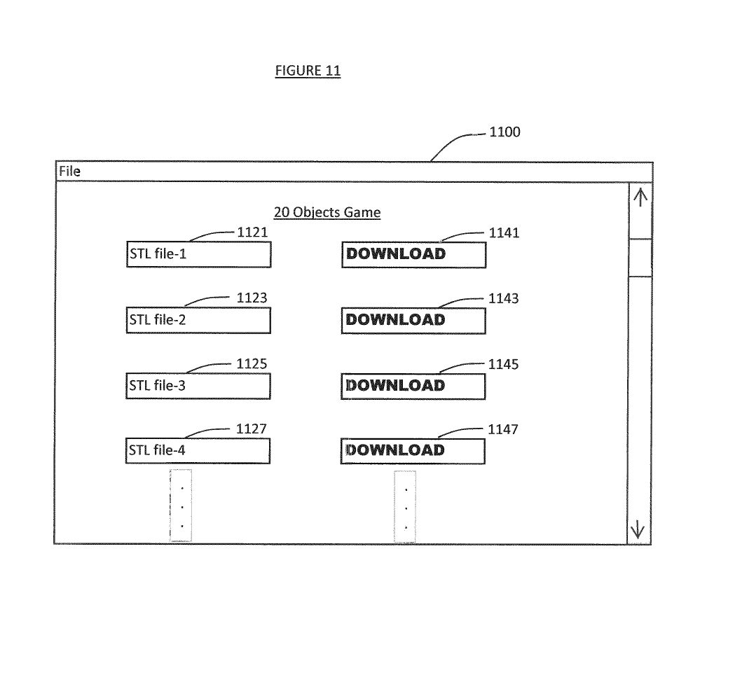

FIG. 10 is a flowchart of a method of conducting an online game in accordance with another embodiment. At step 1010, a plurality of stereolithography (STL) files is provided to each of a plurality of users, by a processor, via a network, wherein the STL files define respective objects related to a selected theme. For example, after users log into the game website, game manager 135 provides to each participant twenty STL files defining twenty different objects relating to a common theme. FIG. 11 shows a web page in accordance with an embodiment. Page 1100 includes a plurality of STL files 1121, 1123, 1125, 1127, etc., that are associated with the “20 Objects Game.” A corresponding “Download” button 1141, 1143, 1145, 1147, etc., is located to the right of each STL file; the user may select the appropriate “Download” button in order to download a desired STL file.

In the illustrative embodiment of FIG. 11, each user may download and print the STL files in any order. As the corresponding objects are printed, the user may examine the various objects and attempt to discern the common theme.

In another embodiment, each user receives one STL file at a time; a subsequent STL file is not provided until the previous STL file is downloaded and printed. In another embodiment, each successive STL file is made available at predetermined intervals, e.g., one STL file per hour, one STL file per day, etc.

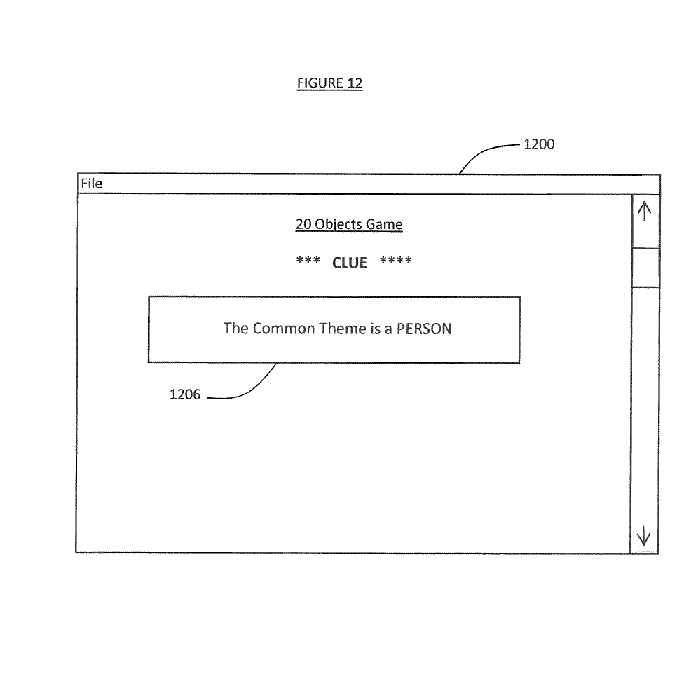

Referring again to FIG. 10, at step 1020, a clue relating to the selected theme is provided to the plurality of users. Game manager 135 may provide one or more clues on a game web page before, or during, the game. For example, game manager 135 may indicate that the common theme is a person, a place, a thing, etc. FIG. 12 shows a clue web page 1200 in which a clue 1206 is provided. Specifically, clue 1206 states that “The Common Theme is a PERSON.”

In other embodiments, a clue may be provided in another form or another format. For example, a clue may be provided in the form of a text file, a .pdf file, a.docx file, a .xlsx file, a .dwg file, a .3do file, etc., that is transmitted to users or made available for download via a network.

In other embodiments, the “20 Objects” game may be conducted without a clue being provided to the users.

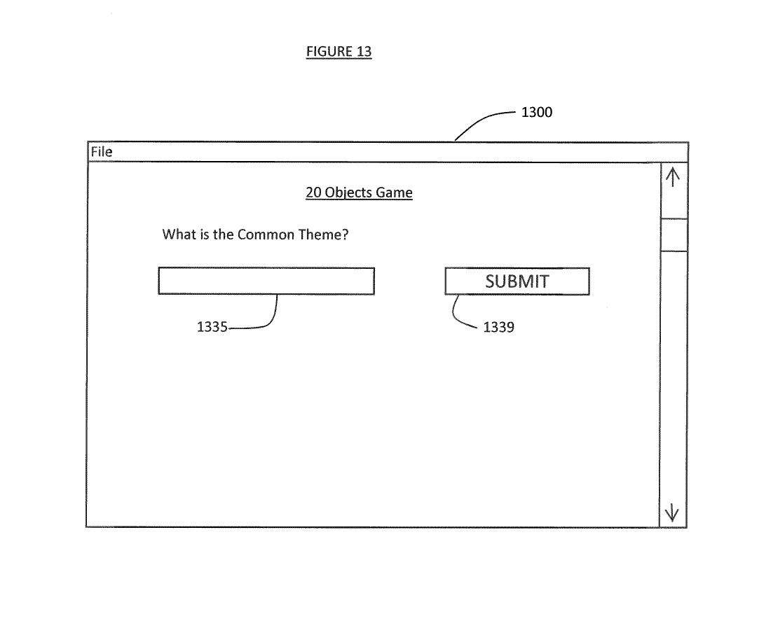

At step 1030, a respective response comprising a respective identification of the theme is received from each of the plurality of users. As users print the objects associated with the various STL files, the users may submit guesses as to the common theme. For example, a user may submit a response indicating his or her guess as to the common theme via a web page such as that shown in FIG. 13. Web page 1300 presents a question “What is the common theme” and includes an answer field 1335. A user who wishes to submit a guess may enter the answer in field 1335 and select a “SUBMIT” option 1339. User device 160 transmits the user's answer to game manager 135, via network 105.

In one embodiment, users may not provide responses until after a predetermined number of objects have been printed. For example, game manager 135 may not accept responses from users until five (5) objects have been printed. In one embodiment, each user may submit an answer only once. In other embodiments, a user may submit multiple answers.

At step 1040, a response correctly identifying the theme is determined. Game manager 135 compares each user's answer to the correct answer to determine which user submits the correct answer. At step 1050, a user who submitted the correct response is designated as a winner. In the illustrative embodiment, game manager 135 designates as the winner that user who first submits an answer correctly identifying the common theme.

In an illustrative example, the common theme is the basketball star Michael Jordan, formerly of the Chicago Bulls. Therefore, game manager 135 distributes STL files defining objects that relate to Michael Jordan. For example, game manager 135 may distribute to user devices 160 STL files that define the following objects:
(1) A bull located near the New York Stock Exchange
(2) The Sears Tower
(3) A basketball
(4) A Tongue
(5) The number 23
   Etc.
   Etc.
   Etc.

In this example, after the third STL file is distributed, game manager 135 provides a clue indicating that “The Object is a Person.”

In another embodiment, game manager 135 selects a plurality of winners. For example, supposing that 300 people participate in the game, the first thirty participants to identify the common theme may be designated as winners.

Game manager 135 may post on each player's web page information indicating how many participants are playing and how many winners have been identified so far.

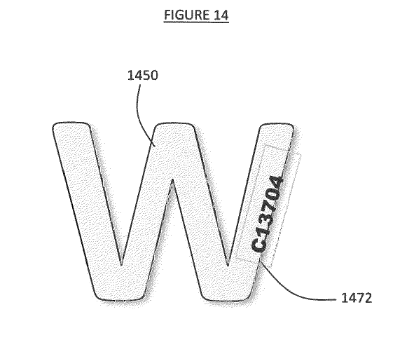

In addition, in another embodiment, game manager 135 may transmit an STL file defining a special object to one or more (randomly selected) participants; a participant who prints out the special object may also be designated a winner. FIG. 14 shows a special object 1450 printed by a 3-D printer in accordance with an embodiment. In this illustrative example, the special object 1450 is a letter “W.” Game manager 135 may transmit the STL file defining the special object after the other files have been transmitted, or at a randomly selected point between two other STL files. Advantageously, offering to participants the chance to receive the special STL file and print out the special object may provide an additional incentive for participants to continue playing until the end of the game.

A special object may also include a number or alphanumeric code (e.g., printed on top of another object) that must be submitted to win. In the illustrative embodiment of FIG. 14, special object 1450 includes a code “C13704” (1472). Game manager 135 may designate all participants who submit the number or code as winners, or may designate only a predetermined number of participants who submit the number/code as winners. For example, game manager 135 may transmit the special STL file to ten participants but designate as winners only the first five participants who submit the number/code. Some participants may win twice in the same game—once for identifying the common theme, for example, and again for submitting the number/code from a special object.

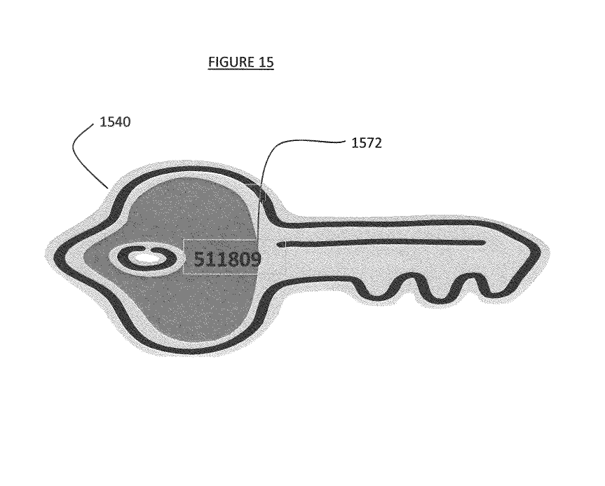

In accordance with another embodiment, game manager 135 provides one or more users an STL file defining a key. A user may download the STL file and use a 3D printer to print it. FIG. 15 shows a key 1540 printed by a 3-D printer using an STL file in accordance with an embodiment.

The key may have defined thereon an identifier such as a number or alphanumeric code associated with the user. In the illustrative embodiment of FIG. 15, key 1540 includes a code “511809” (1572). The key may enable the user to obtain a prize. For example, the user may take the key to a specified store or other location and use it to open a lock, allowing the user to access a particular prize.

In one embodiment, an STL file defining such a key is awarded to a winner of one of the games described above. The winner may obtain a prize by printing the key and using it at a designated location. For example, along with the key, the winner may be informed that he or she may use the key at a particular store (which may be owned/operated by a sponsor of the game, for example) to obtain a prize. The user then prints out the key and visits the specified store, where he or she is invited to open a locked safe containing a prize. In one embodiment, multiple keys are given to a plurality of users and any one of the keys can open the safe. In another embodiment, multiple keys are given to a plurality of users; however, only one of the keys opens the safe. Alternatively, the store may inform the user that one or more designated products are available only to individuals who have the key.

In another embodiment, information enabling users to generate one or more STL files defining one or more objects is provided to a plurality of users, via a network. For example, the information may be provided to users in any suitable form, including, for example, a text file, a .pdf file, a.docx file, a .xlsx file, a .dwg file, a .3do file, etc. The information may be provided in any suitable manner, e.g., posted on a website, transmitted to each user via a network, etc.

The users receive the information, generate the STL files based on the information, and print the one or more objects using 3D printers, based on the STL files. Any of the online games described above, or another game, may then be administered. For example, an online game such as the snowflake game described above, or the twenty questions game described above, may then be played.

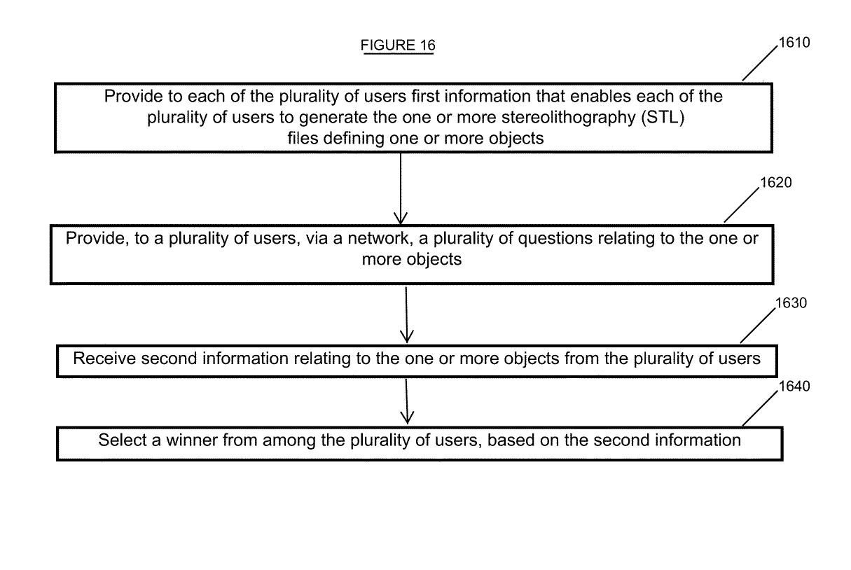

FIG. 16 is a flowchart of a method of conducting a 3D-printer based online game in accordance with an embodiment. At step 1610, first information that enables each of a plurality of users to generate one or more stereolithography (STL) files defining one or more objects is provided to each of the plurality of users. At step 1620, a plurality of questions relating to the one or more objects is provided to a plurality of users, via a network. At step 1630, second information relating to the respective objects is received from the plurality of users. For example, the second information may be received in response to the questions. At step 1640, a winner is selected from among the plurality of users, based on the second information received from the plurality of users. Game manager 135 performs steps 1610, 1620, 1630, and 1640 in the manner described in the illustrative embodiments set forth above.

In one embodiment, any of the games described above may be administered in multiple regions; in each region one or more winners are selected and are awarded a key which may be used to redeem a prize.

In various embodiments, the method steps described herein, including the method steps described in FIGS. 3, 6, 10, and/or 16, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 3, 6, 10, and/or 16, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

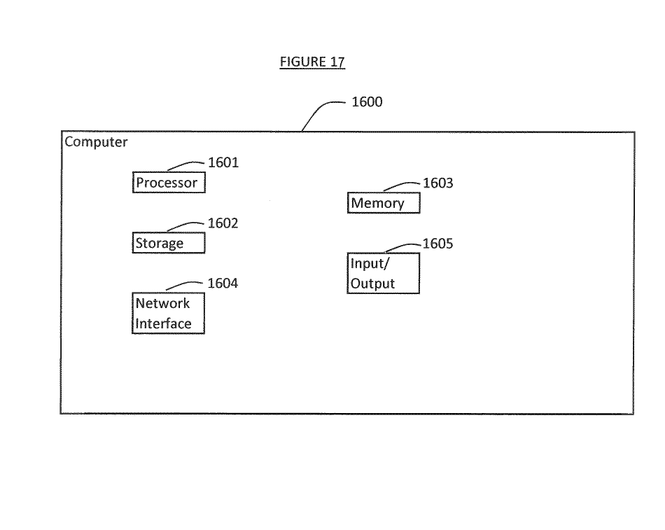

A high-level block diagram of an exemplary computer that may be used to implement systems, apparatus and methods described herein is illustrated in FIG. 17. Computer 1700 includes a processor 1701 operatively coupled to a data storage device 1702 and a memory 1703. Processor 1701 controls the overall operation of computer 1700 by executing computer program instructions that define such operations. The computer program instructions may be stored in data storage device 1702, or other computer readable medium, and loaded into memory 1703 when execution of the computer program instructions is desired. Thus, the method steps of FIGS. 3, 6, 10, and/or 16 can be defined by the computer program instructions stored in memory 1703 and/or data storage device 1702 and controlled by the processor 1701 executing the computer program instructions. For example, the computer program instructions can be implemented as computer executable code programmed by one skilled in the art to perform an algorithm defined by the method steps of FIGS. 3, 6, 10, and/or 16. Accordingly, by executing the computer program instructions, the processor 1701 executes an algorithm defined by the method steps of FIGS. 3, 6, 10, and/or 16. Computer 1700 also includes one or more network interfaces 1704 for communicating with other devices via a network. Computer 1700 also includes one or more input/output devices 1705 that enable user interaction with computer 1700 (e.g., display, keyboard, mouse, speakers, buttons, etc.).

Processor 1701 may include both general and special purpose microprocessors, and may be the sole processor or one of multiple processors of computer 1700. Processor 1701 may include one or more central processing units (CPUs), for example. Processor 1701, data storage device 1702, and/or memory 1703 may include, be supplemented by, or incorporated in, one or more application-specific integrated circuits (ASICs) and/or one or more field programmable gate arrays (FPGAs).

Data storage device 1702 and memory 1703 each include a tangible non-transitory computer readable storage medium. Data storage device 1702, and memory 1703, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1705 may include peripherals, such as a printer, scanner, display screen, etc. For example, input/output devices 1705 may include a display device such as a cathode ray tube (CRT) or liquid crystal display (LCD) monitor for displaying information to the user, a keyboard, and a pointing device such as a mouse or a trackball by which the user can provide input to computer 1700.

Any or all of the systems and apparatus discussed herein, including game manager 135 and user device 160, and components thereof, may be implemented using a computer such as computer 1700.

One skilled in the art will recognize that an implementation of an actual computer or computer system may have other structures and may contain other components as well, and that FIG. 17 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of conducting an online game, the method comprising:
providing one or more stereolithography (STL) files to a plurality of users, by a processor, via a network, wherein the one or more STL files define respective objects;
receiving information relating to the respective objects, by the processor, from the plurality of users; and
selecting a winner from among the plurality of users, based on the information received from the plurality of users.

2. The method of claim 1, wherein each of the plurality of users is associated with a respective 3-D printer.

3. The method of claim 2, further comprising:
providing to each of the plurality of users a single STL file defining a respective object.

4. The method of claim 3, further comprising:
providing to the plurality of users a plurality of questions related to the respective objects.

5. The method of claim 4, further comprising:
receiving, from each of the plurality of users, a respective plurality of answers to the plurality of questions.

6. The method of claim 5, comprising:
for each of the plurality of users:
combining a plurality of answers received from the respective user to generate a code; and
comparing the code to a predetermined code to determine whether or not the respective user is the winner.

7. The method of claim 2, further comprising:
providing to each of the plurality of users a plurality of STL files defining a plurality of objects.

8. The method of claim 1, further comprising:
providing to a selected one of the plurality of users a second STL file defining a key,
wherein the key may be used to redeem a prize.

9. The method of claim 1, further comprising:
providing to a selected one of the plurality of users a second STL file defining a special object; and
designating the selected user as a second winner based on the special object.

10. The method of claim 9, wherein the special object comprises a letter of an alphabet.

11. A system for conducting an online game, the system comprising:
a storage adapted to store one or more stereolithography (STL) files, each STL file defining a respective object;
a processor adapted to:
provide the one or more STL files to a plurality of users, via a network;
receive, from the plurality of users, information relating to the respective objects; and
select a winner from among the plurality of users, based on the information received from the plurality of users.

12. The system of claim 11, wherein each of the plurality of users is associated with a respective 3-D printer.

13. The system of claim 12, wherein the processor is further adapted to:
provide to the plurality of users a plurality of questions related to the respective objects.

14. The system of claim 13, wherein the processor is further adapted to:
receive, from each of the plurality of users, a respective plurality of answers to the plurality of questions.

15. The system of claim 11, wherein the processor is further adapted to:
provide to a selected one of the plurality of users a second STL file defining a key,
wherein the key may be used to redeem a prize.

16. The system of claim 11, wherein the processor is further adapted to:
provide to a selected one of the plurality of users a second STL file defining a special object; and
designate the selected user as a second winner based on the special object.

17. The system of claim 16, wherein the special object comprises a letter of an alphabet.

18. A method of conducting an online game, the method comprising:
providing, by a processor, to a plurality of users, via a network, information relating to one or more stereolithography (STL) files defining one or more objects printable by a 3-D printer;
receiving, by the processor, from the plurality of users, information relating to the one or more objects; and
selecting a winner from among the plurality of users, based on the information received from the plurality of users.

19. The method of claim 18, further comprising:
providing to each of the plurality of users second information that enables each of the plurality of users to generate the one or more STL files.

20. The method of claim 19, wherein the second information comprises one of a text file, a .pdf file, a.docx file, a .xlsx file, a .dwg file, a .3do file.
